(19) United States
(12) Patent Application Publication
(10) Pub. No.: US 2026/0163604 A1
(43) Pub. Date: Jun. 11, 2026

(54) RADIO-FREQUENCY DEVICE AND MULTIPLEXER

(71) Applicant: Murata Manufacturing Co., Ltd., Nagaokakyo-shi (JP)

(72) Inventor: Akira NOGUCHI, Nagaokakyo-shi (JP)

(21) Appl. No.: 19/405,824

(22) Filed: Dec. 2, 2025

(30) Foreign Application Priority Data
Dec. 9, 2024 (JP) 2024-214635

(51) Int. Cl. H04B 1/525

(52) U.S. Cl. CPC H04B 1/525

(57) ABSTRACT

A radio-frequency device includes a substrate including first and second surfaces, and a chip component mounted on the first surface of the substrate. The substrate includes a signal electrode, a signal line, a lead-out line, a reference potential electrode, and an inductor. The signal electrode is located on the second surface and electrically connected to a functional element of the chip component with the signal line interposed therebetween. The lead-out line includes first and second ends. A first end portion of the inductor is connected to the second end of the lead-out line, and a second end portion of the inductor is connected to the reference potential electrode. The first end of the lead-out line is connected to the signal electrode or the signal line on the second surface side relative to the first end portion of the inductor.

### CROSS REFERENCE TO RELATED APPLICATIONS

This application claims the benefit of priority to Japanese Patent Application No. 2024-214635 filed on Dec. 9, 2024. The entire contents of this application are hereby incorporated herein by reference.

### BACKGROUND OF THE INVENTION

### 1. Field of the Invention

The present invention relates to radio-frequency (RF) devices and multiplexers.

### 2. Description of the Related Art

Conventionally, as a radio-frequency (RF) device provided in mobile communication terminals and the like, RF devices including a filter and an inductor are known. Japanese Unexamined Patent Application Publication No. 2019-9583 discloses an RF device including a chip component mounted on a substrate and an inductor formed in the substrate. In this RF device, an RF signal input to the substrate is supplied to a filter of the chip component through a line in the substrate.

In such conventional RF devices, a large current flows through the line in the substrate and causes unwanted loss in the RF signal.

### SUMMARY OF THE INVENTION

Example embodiments of the present invention provide RF devices that are each able to reduce or prevent an occurrence of unwanted loss in an RF signal.

A radio-frequency (RF) device according to an example embodiment of the present invention includes a substrate including a first surface and a second surface, and a chip component mounted on the first surface of the substrate. The substrate includes a signal electrode, a signal line, a lead-out line, a reference potential electrode, and an inductor. The signal electrode is on the second surface and electrically connected to a functional element of the chip component with the signal line interposed therebetween. The lead-out line includes a first end and a second end. A first end portion of the inductor is connected to the second end of the lead-out line, and a second end portion of the inductor is connected to the reference potential electrode. The first end of the lead-out line is connected to the signal electrode or the signal line on the second surface side relative to the first end portion of the inductor.

A multiplexer according to an example embodiment of the present invention includes an RF device according to an example embodiment of the present invention.

According to example embodiments of the present invention RF devices, RF devices each able to reduce or prevent an occurrence of unwanted loss in an RF signal are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram schematically illustrating the cross-section of an RF device according to a comparative example of the present invention.

FIG. 2 is a circuit configuration diagram of an RF device according to an example embodiment of the present invention.

FIG. 3 is a diagram schematically illustrating a cross-section of an RF device according to an example embodiment of the present invention.

FIG. 4 is a diagram illustrating circuit patterns provided on base material sheets of individual layers of an RF device according to an example embodiment of the present invention.

FIGS. 5A and 5B include diagrams illustrating insertion loss of RF devices according to an example embodiment of the present invention and the a comparative example.

FIG. 6 is a circuit configuration diagram of an RF device according to a first modification of an example embodiment of the present invention.

FIG. 7 is a diagram schematically illustrating a cross-section of an RF device according to the first modification of an example embodiment of the present invention.

FIG. 8 is a diagram illustrating insertion loss of an RF devices according to the first modification of an example embodiment and a comparative example.

FIG. 9 is a diagram schematically illustrating a cross-section of an RF device according to a second modification of an example embodiment of the present invention.

FIG. 10 is a diagram schematically illustrating a cross-section of an RF device according to a third modification of an example embodiment of the present invention.

FIG. 11 is a diagram schematically illustrating a cross-section of an RF device according to a fourth modification of an example embodiment of the present invention.

FIG. 12 is a diagram schematically illustrating a cross-section of an RF device according to a fifth modification of an example embodiment of the present invention.

### DETAILED DESCRIPTION OF THE EXAMPLE EMBODIMENTS

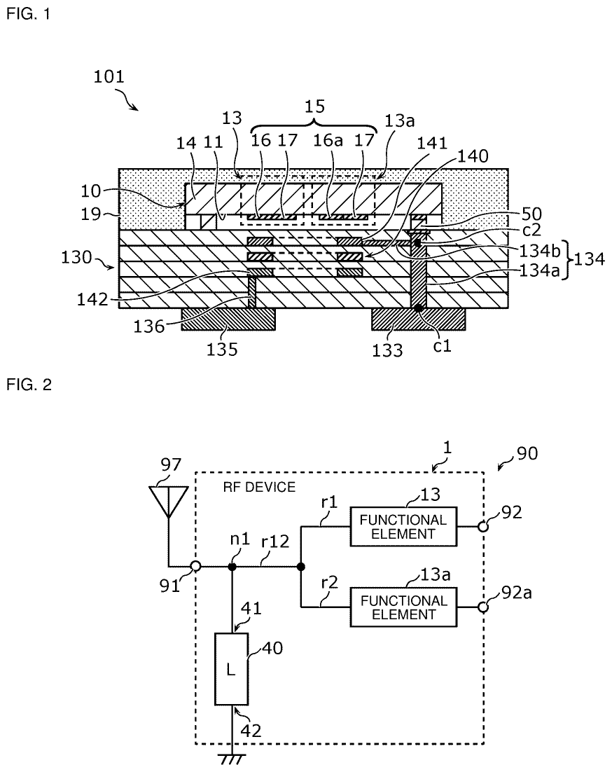

FIG. 1 is a diagram schematically illustrating the cross-section of an RF device 101 according to a comparative example.

The RF device 101 of the comparative example includes a substrate 130 and a chip component 10 mounted on the substrate 130. The periphery of the chip component 10 is sealed with resin 19.

The chip component 10 includes a functional element 13 including a base material 14 and a functional electrode 16, and a functional element 13a including the base material 14 and a functional electrode 16a. Additionally, the chip component 10 includes a conductor portion 15 and a terminal electrode 18. The conductor portion 15 includes the functional electrodes 16 and 16a and a wiring electrode 17 provided on the main surface of the base material 14. The conductor portion 15 is provided on a first opposing surface 11 of the chip component 10. The conductor portion 15 is electrically connected to an internal conductor of the substrate 130 with a bump electrode 50 interposed therebetween.

The substrate 130 includes a signal electrode 133, a first line 134 connected to the signal electrode 133, a ground electrode 135, a second line 136 connected to the ground electrode 135, and an inductor 140. The first line 134 includes a signal line 134a and a lead-out line 134b.

The signal electrode 133 is electrically connected to the functional elements 13 and 13a of the chip component 10 with the signal line 134a interposed therebetween. A first end portion 141 of the inductor 140 is connected to the signal electrode 133 with the lead-out line 134b and a portion of the signal line 134a interposed therebetween. A second end portion 142 of the inductor 140 is connected to the ground electrode 135 with the second line 136 interposed therebetween.

In the comparative example, the lead-out line 134b extends laterally from the first end portion 141 of the inductor 140 and is connected to the signal line 134a at the same height position as the first end portion 141. Therefore, the distance from the point (connection point c1) where the signal line 134a is connected to the signal electrode 133 to the point (connection point c2) where the lead-out line 134b is connected to the signal line 134a becomes long. As a result, a large current flows through the signal line 134a from the connection point c1 to the connection point c2 and causes unwanted loss in the RF signal.

In contrast, RF devices according to example embodiments of the present invention have configurations that reduce or prevent the flow of a large current through the signal line in the substrate. This, in turn, makes it possible to reduce or prevent the occurrence of unwanted loss in the RF signal.

Example embodiments of the present invention will be described in detail below with reference to the drawings. The example embodiments described below are provided as comprehensive or specific examples. The numerical values, shapes, materials, components, arrangement and connection configurations of components, and the like discussed in the following example embodiments are merely examples and are not intended to limit the scope of the present invention. In the drawings, the same reference numerals are provided to identical or substantially identical configurations, and repeated explanation may be omitted or simplified. Additionally, in the example embodiments described below, “connected” refers not only to direct connection but also to electrical connection with another element or the like interposed therebetween.

The configuration of an RF device according to an example embodiment of the present invention will be described with reference to FIGS. 2 to 5B.

FIG. 2 is a circuit configuration diagram of an RF device 1 according to an example embodiment of the present invention.

As illustrated in FIG. 2, the RF device 1 includes the functional elements 13 and 13a and an inductor 40. Also illustrated in FIG. 2 are an antenna element 97, and input/output terminals 91, 92, and 92a, to and from which an RF signal is input and output.

The functional elements 13 and 13a are, for example, receiving filters. The functional elements 13 and 13a may be receiving filters or transmitting filters, for example. Although two functional elements are illustrated in FIG. 2, one or multiple functional elements may be provided. Multiple functional elements may define a quadplexer with, for example, Band 1 and Band 3 as its passbands.

Each of the functional elements 13 and 13a includes one or more acoustic wave resonators. The one or more acoustic wave resonators include, for example, at least one of a SAW (Surface Acoustic Wave) resonator, a BAW (Bulk Acoustic Wave) resonator, or an XBAR (Laterally Excited Film Bulk Acoustic Wave Resonator). SAW includes not only surface waves but also boundary waves. A SAW resonator includes a piezoelectric substrate (a piezoelectric film, a low acoustic velocity film, and a high acoustic velocity film or a high acoustic velocity support substrate) and an IDT electrode provided thereon as the functional electrode 16. A BAW resonator includes a support substrate made of, for example, silicon or the like and the functional electrode 16 as an electrode sandwiching a piezoelectric film.

The functional element 13 is provided on a line r1 connecting the input/output terminal 91 and the input/output terminal 92. The functional element 13a is provided on a line r2 connecting the input/output terminal 91 and the input/output terminal 92a. The antenna element 97 is connected to the input/output terminal 91. Additionally, a first end of the functional element 13 and a first end of the functional element 13a are connected to the input/output terminal 91.

The input/output terminal 92 is connected to a second end of the functional element 13. The input/output terminal 92a is connected to a second end of the functional element 13a. When the functional elements 13 and 13a are receiving filters, an LNA (Low Noise Amplifier) and a signal processing circuit are connected in this order to the input/output terminal 92, and an LNA and a signal processing circuit are connected in this order to the input/output terminal 92a. When multiple functional elements define a quadplexer having Band 1 and Band 3 as its passbands, the total number of input/output terminals 92 and 92a will be four. Two of the four input/output terminals each include an LNA and a signal processing circuit connected in this order, while the other two input/output terminals each include a power amplifier and a signal processing circuit connected in this order.

The RF device 1 may be configured to be included in a multiplexer 90. In other words, the RF device 1 may have a configuration in which the input/output terminals 91, 92, and 92a of the multiple functional elements 13 and 13a are directly or indirectly connected to an antenna common terminal. The multiplexer 90 may be, for example, a diplexer when the number of functional elements is two, a triplexer when the number is three, or a quadplexer when the number is four. Note that there may be five or more functional elements.

The inductor 40 is connected to a portion of a line r12 between the input/output terminal 91 and the functional elements 13 and 13a. A first end portion 41 of the inductor 40 is connected to a first node n1, which is a portion of the line r12, whereas a second end portion 42 of the inductor 40 is connected to ground.

In the RF device 1 of the present example embodiment, the functional elements 13 and 13a are provided in the chip component 10, and the inductor 40 is provided in a substrate 30.

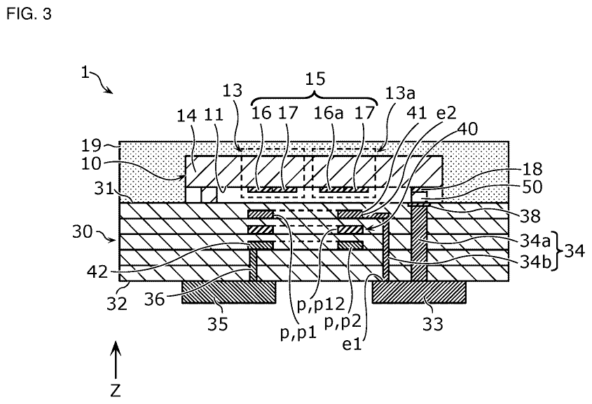

FIG. 3 is a diagram schematically illustrating the cross-section of the RF device 1.

As illustrated in FIG. 3, the RF device 1 includes the substrate 30 including a first surface 31 and a second surface 32, and the chip component 10 mounted on the substrate 30. The periphery of the chip component 10 is sealed with the resin 19. The resin 19 covers the first surface 31 of the substrate 30 and the top and side surfaces of the chip component 10. The chip component 10 need not necessarily be covered with the resin 19.

In FIG. 3, the direction perpendicular or substantially perpendicular to the substrate 30 defines the Z direction. The direction perpendicular or substantially perpendicular to the substrate 30 is the same direction as the thickness direction of the substrate 30. Additionally, the direction perpendicular or substantially perpendicular to the substrate 30 is also a direction perpendicular or substantially perpendicular to the first surface 31 and the second surface 32, which are two main surfaces of the substrate 30. In the present example embodiment, the arrow direction in the Z direction may be referred to as the top side, whereas the direction opposite to the arrow direction may be referred to as the bottom side.

The chip component 10 is mounted on the first surface 31 of the substrate 30 using the bump electrode 50.

The chip component 10 is disposed closer to the first surface 31 than the second surface 32 of the substrate 30. The chip component 10 has a rectangular or substantially rectangular parallelepiped shape and includes the first opposing surface 11 facing the first surface 31 of the substrate 30. The first opposing surface 11 faces the first surface 31 across the space located between the substrate 30 and the chip component 10.

The chip component 10 includes the functional element 13 including the base material 14 and the functional electrode 16, and the functional element 13a including the base material 14 and the functional electrode 16a. Additionally, the chip component 10 includes the conductor portion 15 and the terminal electrode 18. The conductor portion 15 includes the functional electrodes 16 and 16a and the wiring electrode 17 provided on the main surface of the base material 14. The conductor portion 15 is provided on the first opposing surface 11 of the chip component 10.

Although the conductor portion 15 illustrated in FIG. 3 includes the functional electrodes 16 and 16a and the wiring electrode 17, the conductor portion 15 only needs to include at least one of the functional electrodes 16 and 16a and the wiring electrode 17. In FIG. 3, the wiring electrode 17, which is a portion of the conductor portion 15, is provided in the functional elements 13 and 13a. However, the wiring electrode 17 may also be provided outside the functional elements 13 and 13a.

The conductor portion 15 is exposed to the space between the substrate 30 and the chip component 10. A protective film (for example, SiO₂) may be provided on the surface of the conductor portion 15. The conductor portion 15 may also be provided not only on the first opposing surface 11, but also inside the chip component 10. For example, the functional elements 13 and 13a may be provided in a hollow region inside the chip component 10.

The wiring electrode 17 extends from the functional elements 13 and 13a, and is connected to the bump electrode 50 with the terminal electrode 18, which is a portion of the wiring electrode 17, interposed therebetween. That is, the conductor portion 15 is electrically connected to an internal conductor of the substrate 30 with the bump electrode 50 interposed therebetween.

The substrate 30 has a rectangular or substantially rectangular parallelepiped shape. The substrate 30 is, for example, a multilayer substrate formed by laminating multiple base material sheets. The substrate 30 may be, for example, a circuit board including a ceramic material, or a flexible circuit board including a resin material. In FIG. 3, the boundary surfaces between the base material sheets laminated vertically are also illustrated.

The first surface 31 and the second surface 32, which are the two main surfaces of the substrate 30, are parallel or substantially parallel to each other. The first surface 31 is located on the front surface of the substrate 30, and the second surface 32 is located on the back surface opposite to the front surface of the substrate 30. The first surface 31 is a surface on which the chip component 10 is mounted. The second surface 32 is, when the RF device 1 is mounted on another printed circuit board, a surface that faces the printed circuit board.

The substrate 30 includes a signal electrode 33, a first line 34 connected to the signal electrode 33, a reference potential electrode 35, a second line 36 connected to the reference potential electrode 35, and the inductor 40. The signal electrode 33, the first line 34, the reference potential electrode 35, the second line 36, and the inductor 40 are made of, for example, a metal material including copper as a main component.

The first end portion 41 of the inductor 40 is connected to the signal electrode 33 with the first line 34 interposed therebetween. Specifically, the first end portion 41 of the inductor 40 is connected to a second end e2 of a lead-out line 34b, which is a portion of the first line 34. The second end portion 42 of the inductor 40 is electrically connected to the reference potential electrode 35. Specifically, the second end portion 42 of the inductor 40 is connected to the reference potential electrode 35 with the second line 36 interposed therebetween.

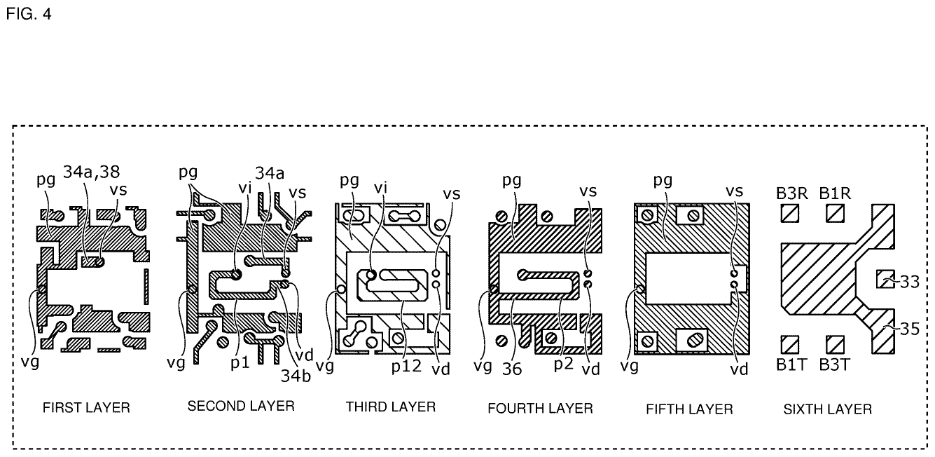

The inductor 40 includes multiple conductor patterns p and a conductor via vi (see FIG. 4) that connects the conductor patterns p to one another. Each conductor pattern p is provided on the base material sheet of the corresponding layer and is parallel or substantially parallel to the first surface 31. The inductor 40 is provided such that the coil axis of the inductor 40 is perpendicular or substantially perpendicular to the substrate 30.

The inductor 40 illustrated in FIG. 3 includes three layers of conductor patterns p. The inductor 40 includes a first conductor pattern p1 that is closest to the first surface 31 among the multiple conductor patterns p, a second conductor pattern p2 that is closest to the second surface 32, and another conductor pattern p12 that is located between the first conductor pattern p1 and the second conductor pattern p2. Two or more conductor patterns may be provided between the first conductor pattern p1 and the second conductor pattern p2, or no conductor pattern may be provided therebetween.

The first conductor pattern p1 is connected to the signal electrode 33 with the first line 34 interposed therebetween. The second conductor pattern p2 is connected to the reference potential electrode 35 with the second line 36 interposed therebetween.

The reference potential electrode 35 is provided on the second surface 32 of the substrate 30. The reference potential electrode 35 is an external terminal for grounding, for example, and is set to a reference potential (e.g., a ground potential). The reference potential electrode 35 in the present example embodiments corresponds to ground in the circuit configuration diagram of FIG. 2.

The second line 36 is a line different from the first line 34 and is provided inside the substrate 30. The second line 36 includes a line pattern and a conductor via vg (see FIG. 4) in the substrate 30. A first end of the second line 36 is connected to the second end portion 42 of the inductor 40, and a second end of the second line 36 is connected to the reference potential electrode 35.

The signal electrode 33 is provided on the second surface 32 of the substrate 30. The signal electrode 33 is an external terminal for signal input, for example, and receives an RF signal input to the antenna element 97. The signal electrode 33 is electrically connected to the functional elements 13 and 13a of the chip component 10 with a signal line 34a, which is a portion of the first line 34, and the bump electrode 50 interposed therebetween.

The first line 34 is provided inside the substrate 30 and on the first surface 31. The first line 34 includes multiple line patterns, a conductor via vs, and a conductor via vd (see FIG. 4) provided in the substrate 30. On the first surface 31, a land electrode 38, which is a portion of the first line 34, is provided. The first line 34 includes the signal line 34a and the lead-out line 34b.

The signal line 34a is a line that electrically connects the signal electrode 33 and the bump electrode 50. A first end of the signal line 34a is connected to the signal electrode 33 on the second surface 32 of the substrate 30. The land electrode 38, which is a second end of the signal line 34a, is exposed to the first surface 31 of the substrate 30 and is connected to the bump electrode 50. That is, the signal line 34a extends from the second surface 32 to the first surface 31 and is electrically connected to the functional elements 13 and 13a of the chip component 10. In the FIG. 3, the signal line 34a is provided linearly by a line perpendicular or substantially perpendicular to the second surface 32, but it is not limited thereto. For example, the signal line 34a may have a stepped shape including a line perpendicular or substantially perpendicular to the second surface 32, a line parallel or substantially parallel to the first surface 31, and a line perpendicular or substantially perpendicular to the first surface 31.

The lead-out line 34b is a line to electrically connect the signal electrode 33 and the inductor 40. The lead-out line 34b extends from an end portion of the first conductor pattern p1 that is closest to the first surface 31 among the multiple conductor patterns p, and is connected to the signal electrode 33. The lead-out line 34b includes a first end e1 and a second end e2, which are two ends of the lead-out line 34b. The first end e1 of the lead-out line 34b is connected to the signal electrode 33, and the second end e2 of the lead-out line 34b is connected to the first end portion 41 of the inductor 40.

In the present example embodiment, the first end e1 of the lead-out line 34b is directly connected to the signal electrode 33 on the second surface 32 side relative to the first end portion 41 of the inductor 40. Additionally, the first end e1 of the lead-out line 34b is connected to a region different from the signal line 34a on the signal electrode 33. The signal electrode 33, to which the first end e1 of the lead-out line 34b is connected, corresponds to the input/output terminal 91 and the first node n1 in the circuit configuration diagram of FIG. 2.

The circuit patterns on the base material sheets of the individual layers, on which the inductor 40, the first line 34, the signal electrode 33, the second line 36, the reference potential electrode 35, and the like are provided, will be described in detail. Here, circuit patterns corresponding to a quadplexer including, for example, Band 1 and Band 3 as its passbands will be described as an example.

FIG. 4 is a diagram illustrating the circuit patterns provided on the base material sheets of the respective layers of the RF device 1. In FIG. 4, the circuit patterns of the first through sixth layers, counted from the top, are illustrated in this order. Each of the conductor vias vs, vg, vi, and vd described below is a conductor extending in the depth direction of the page so as to penetrate through the base material sheet.

The circuit pattern of the first layer includes the land electrode 38 and the conductor via vs defining a portion of the signal line 34a, and a ground pattern pg and the conductor via vg located at the outer periphery of the base material sheet. The land electrode 38 is connected to the signal line 34a of the second layer with the conductor via vs interposed therebetween. The ground pattern pg of the first layer is connected to the ground pattern pg of the second layer with the conductor via vg interposed therebetween.

The circuit pattern of the second layer includes the first conductor pattern p1 including about ⅞ turns, the conductor via vi of the inductor 40, a line pattern and the conductor via vs defining a portion of the signal line 34a, a line pattern and the conductor via vd defining a portion of the lead-out line 34b, and the ground pattern pg and the conductor via vg located at the outer periphery of the base material sheet. The first conductor pattern p1 is connected to the conductor pattern p12 of the third layer with the conductor via vi interposed therebetween. A portion of the signal line 34a is connected to the conductor via vs of the third layer with the conductor via vs interposed therebetween. A portion of the lead-out line 34b is connected to the conductor via vd of the third layer with the conductor via vd interposed therebetween. The ground pattern pg of the second layer is connected to the ground pattern pg of the third layer with the conductor via vg interposed therebetween.

The circuit pattern of the third layer includes the conductor pattern p12 including about ⅞ turns, the conductor via vi of the inductor 40, the conductor via vs defining a portion of the signal line 34a, the conductor via vd defining a portion of the lead-out line 34b, and the ground pattern pg and the conductor via vg located at the outer periphery of the base material sheet. The conductor pattern p12 is connected to the second conductor pattern p2 of the fourth layer with the conductor via vi interposed therebetween. The conductor via vs of the third layer is connected to the conductor via vs defining a portion of the signal line 34a of the fourth layer. The conductor via vd of the third layer is connected to the conductor via vd defining a portion of the lead-out line 34b of the fourth layer. The ground pattern pg of the third layer is connected to the ground pattern pg of the fourth layer with the conductor via vg interposed therebetween.

The circuit pattern of the fourth layer includes the second conductor pattern p2 including about ¾ turns, the conductor via vs defining a portion of the second line 36 and a portion of the signal line 34a, the conductor via vd defining a portion of the lead-out line 34b, and the ground pattern pg and the conductor via vg located at the outer periphery of the base material sheet. The second conductor pattern p2 is connected to the ground pattern pg with the second line 36 interposed therebetween. The conductor via vs of the fourth layer is connected to the conductor via vs defining a portion of the signal line 34a of the fifth layer. The conductor via vd of the fourth layer is connected to the conductor via vd defining a portion of the lead-out line 34b of the fifth layer. The ground pattern pg of the fourth layer is connected to the ground pattern pg of the fifth layer with the conductor via vg interposed therebetween.

The circuit pattern of the fifth layer includes the conductor via vs defining a portion of the signal line 34a, the conductor via vd defining a portion of the lead-out line 34b, and the ground pattern pg and the conductor via vg located at the outer periphery of the base material sheet. The conductor via vs of the fifth layer is connected to the signal electrode 33 of the sixth layer. The conductor via vd of the fifth layer is also connected to the signal electrode 33 of the sixth layer. The ground pattern pg of the fifth layer is connected to the reference potential electrode 35 of the sixth layer with the conductor via vg interposed therebetween.

The circuit pattern of the sixth layer includes the signal electrode 33 and the reference potential electrode 35. Each of the signal electrode 33 and the reference potential electrode 35 is provided at an outer peripheral end portion of the base material sheet. The signal electrode 33 is connected to the signal line 34a of the upper layers with the conductor via vs and the like interposed therebetween, and is also connected to the lead-out line 34b of the upper layers with the conductor via vd and the like interposed therebetween. The conductor vias vs and vd are adjacent to each other when viewed in a direction perpendicular or substantially perpendicular to the first surface 31 of the substrate 30, and are connected to different regions on the signal electrode 33.

The reference potential electrode 35 is provided in a region extending from the outer peripheral end portion of the base material sheet to the center. The reference potential electrode 35 is connected to the ground patterns pg of the upper layers with the conductor via vg and the like interposed therebetween. The ground patterns pg provided on the base material sheets of the first to fifth layers are connected to each other with the conductor via vg provided in the base material sheets interposed therebetween.

Additionally, the circuit pattern of the sixth layer includes terminals B1R, B1T, B3R, and B3T. These terminals correspond to the input/output terminals 92 and 92a in the circuit configuration diagram of FIG. 2. These terminals are connected to the terminal electrodes B1R, B1T, B3R and B3T of the chip component 10 with conductor vias provided in the layers, bump electrode, and the like interposed therebetween (not illustrated).

For example, in the RF device 1 illustrated in FIG. 3, when the input/output terminals 92 and 92a are provided on the second surface 32 of the substrate 30, the second ends of the functional elements 13 and 13a of the chip component 10 may be connected to the input/output terminals 92 and 92a with bump electrodes, conductor vias in the substrate 30, and the like interposed therebetween (not illustrated).

In the RF device 1 of the present example embodiment, the signal electrode 33 provided on the second surface 32 of the substrate 30 is electrically connected to the functional elements 13 and 13a of the chip component 10 with the signal line 34a interposed therebetween. Additionally, the second end e2 of the lead-out line 34b is connected to the first end portion 41 of the inductor 40, and the first end e1 of the lead-out line 34b is connected to the signal electrode 33 on the second surface 32 side relative to the first end portion 41 of the inductor 40. According to this configuration, the RF signal input to the signal electrode 33 is branched at the signal electrode 33 and transmitted separately through the signal line 34a and the lead-out line 34b. Therefore, it is possible to reduce or prevent a large current from flowing through the signal line 34a. This, in turn, makes it possible to reduce or prevent the occurrence of unwanted loss in the RF signal.

In the above description, an example in which the lead-out line 34b is connected to the signal electrode 33 has been described. However, the configuration is not limited thereto. For example, the lead-out line 34b may extend from the first end portion 41 of the inductor 40 and be connected to the signal line 34a on the second surface 32 side relative to the first end portion 41.

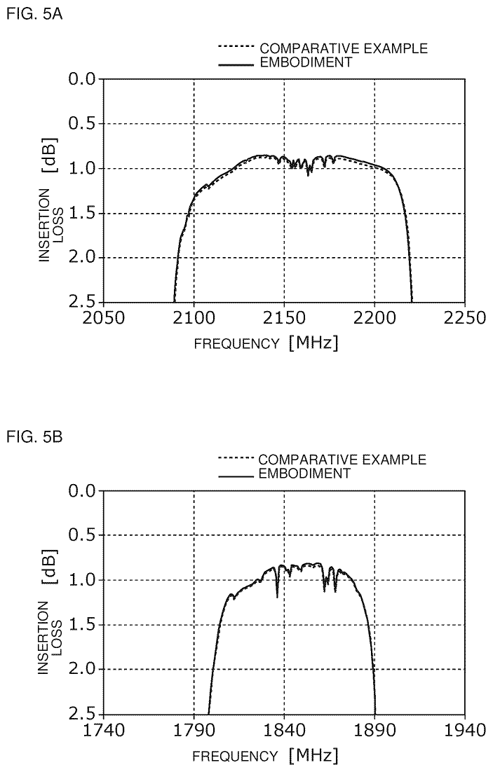

The advantageous effects of the RF device 1 according to the present example embodiment will be described with reference to FIGS. 5A and 5B.

FIGS. 5A and 5B are diagrams illustrating the insertion loss of the RF devices of the present example embodiment and the comparative example.

FIGS. 5A and 5B include diagrams illustrating the insertion loss of an RF signal input to the RF device 1 or 101 from the input/output terminal 91. FIG. 5A illustrates the insertion loss of a receiving filter having Band 66 as its passband, and FIG. 5B illustrates the insertion loss of a receiving filter having Band 3 as its passband.

As illustrated in FIGS. 5A and 5B, the insertion loss in the passband is smaller in the present example embodiment than in the comparative example. According to the RF device 1 of the present example embodiment, the occurrence of the insertion loss in the passband can be reduced or prevented compared to the RF device 101 of the comparative example.

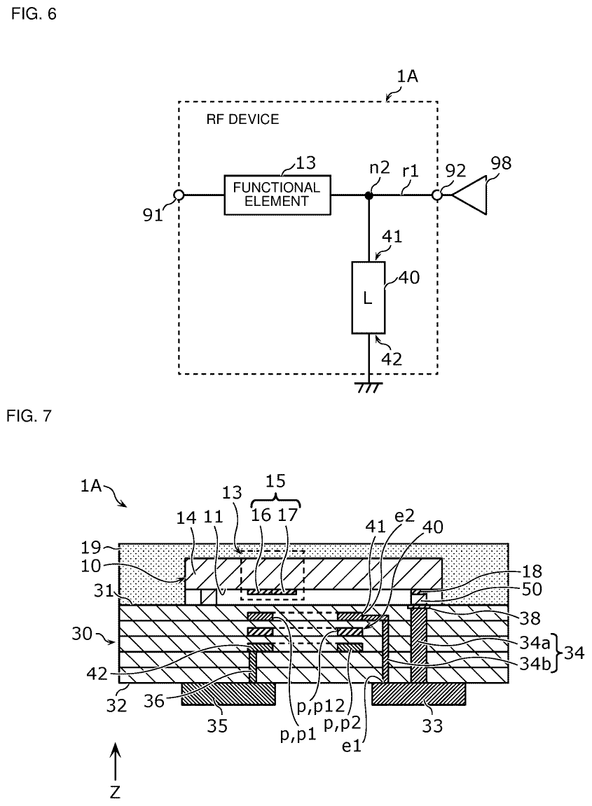

The configuration of an RF device 1A according to a first modification of an example embodiment of the present invention will be described with reference to FIGS. 6 and 7. In the first modification, the case where the functional element 13 of the RF device 1A is a transmitting filter will be described as an example.

FIG. 6 is a circuit configuration diagram of the RF device 1A according to the first modification.

As illustrated in FIG. 6, the RF device 1A includes the functional element 13 and the inductor 40. Also illustrated in FIG. 6 are a power amplifier 98 and the input/output terminals 91 and 92, to and from which an RF signal is input and output.

The functional element 13 includes one or more acoustic wave resonators. The one or more acoustic wave resonators include at least one of a SAW resonator, a BAW resonator, or an XBAR, for example. A SAW resonator includes not only surface waves but also boundary waves. The functional element 13 of the present modification is, for example, a transmitting filter.

The functional element 13 is provided on a line r1 connecting the input/output terminal 91 and the input/output terminal 92. A first end of the functional element 13 is connected to the input/output terminal 91. The input/output terminal 92 is connected to a second end of the functional element 13. When the functional element 13 is a transmitting filter, the power amplifier 98 and a signal processing circuit are connected in this order to the input/output terminal 92.

The inductor 40 is connected to a portion of the line r1 between the functional element 13 and the input/output terminal 92. The first end portion 41 of the inductor 40 is connected to a second node n2, which is a portion of the line r1, and the second end portion 42 of the inductor 40 is connected to ground.

In the RF device 1A of the first modification, the functional element 13 is provided in the chip component 10, and the inductor 40 is provided in the substrate 30.

FIG. 7 is a diagram schematically illustrating the cross-section of the RF device 1A.

As illustrated in FIG. 7, the RF device 1A includes the substrate 30 including the first surface 31 and the second surface 32, and the chip component 10 mounted on the substrate 30. The configuration of the chip component 10 of the first modification is the same as or similar to that of the example embodiments described above. The configuration of the substrate 30 of the first modification is the same as or similar to that of the example embodiments described above.

The substrate 30 includes the signal electrode 33, the first line 34 connected to the signal electrode 33, the reference potential electrode 35, the second line 36 connected to the reference potential electrode 35, and the inductor 40.

The reference potential electrode 35 is an external terminal for grounding, for example, and is set to a reference potential (e.g., a ground potential). The reference potential electrode 35 in the present example embodiment corresponds to ground in the circuit configuration diagram of FIG. 6.

A first end of the second line 36 is connected to the second end portion 42 of the inductor 40, and a second end of the second line 36 is connected to the reference potential electrode 35.

The signal electrode 33 is an external terminal for signal input, for example, and receives an RF signal output from the power amplifier 98. The signal electrode 33 is electrically connected to the functional element 13 of the chip component 10 with the signal line 34a, which is a portion of the first line 34, and the bump electrode 50 interposed therebetween.

The first line 34 includes the signal line 34a and the lead-out line 34b.

The signal line 34a is a line that electrically connects the signal electrode 33 and the bump electrode 50. A first end of the signal line 34a is connected to the signal electrode 33 on the second surface 32 of the substrate 30. The land electrode 38, which is a second end of the signal line 34a, is exposed to the first surface 31 of the substrate 30 and is connected to the bump electrode 50. That is, the signal line 34a extends from the second surface 32 to the first surface 31 and is electrically connected to the functional element 13 of the chip component 10.

The lead-out line 34b is a line to electrically connect the signal electrode 33 and the inductor 40. The lead-out line 34b extends from an end portion of the first conductor pattern p1 that is closest to the first surface 31 among the multiple conductor patterns p, and is connected to the signal electrode 33. The first end e1 of the lead-out line 34b is connected to the signal electrode 33, and the second end e2 of the lead-out line 34b is connected to the first end portion 41 of the inductor 40.

In the first modification, the first end e1 of the lead-out line 34b is directly connected to the signal electrode 33 on the second surface 32 side relative to the first end portion 41 of the inductor 40. Additionally, the first end e1 of the lead-out line 34b is connected to a region different from the signal line 34a on the signal electrode 33. The signal electrode 33, to which the first end e1 of the lead-out line 34b is connected, corresponds to the input/output terminal 92 and the second node n2 in the circuit configuration diagram of FIG. 6.

In the RF device 1A of the first modification, the signal electrode 33 provided on the second surface 32 of the substrate 30 is electrically connected to the functional element 13 of the chip component 10 with the signal line 34a interposed therebetween. Additionally, the second end e2 of the lead-out line 34b is connected to the first end portion 41 of the inductor 40, and the first end e1 of the lead-out line 34b is connected to the signal electrode 33 on the second surface 32 side relative to the first end portion 41 of the inductor 40. According to this configuration, the RF signal input to the signal electrode 33 is branched at the signal electrode 33 and transmitted separately through the signal line 34a and the lead-out line 34b. Therefore, it is possible to reduce or prevent a large current from flowing through the signal line 34a. This, in turn, makes it possible to reduce or prevent the occurrence of unwanted loss in the RF signal.

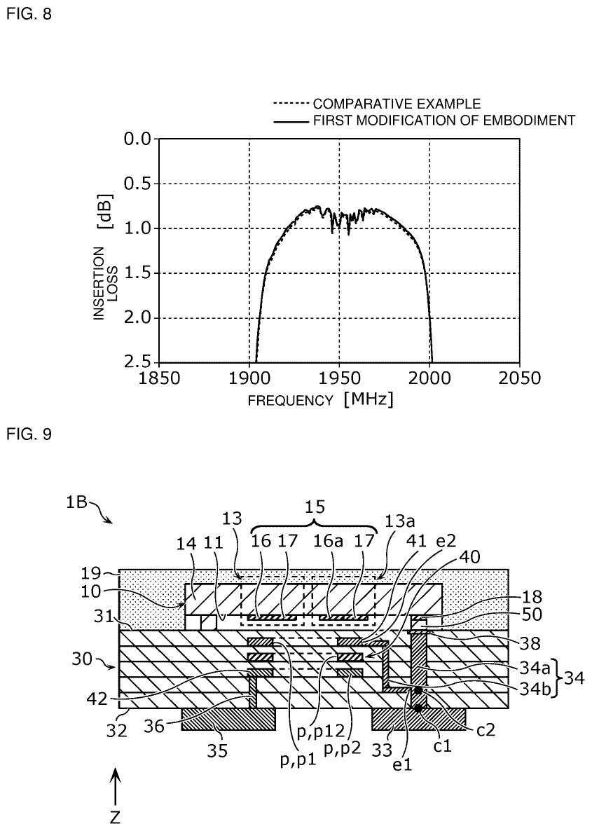

The advantageous effects of the RF device 1A according to the first modification will be described with reference to FIG. 8.

FIG. 8 is a diagram illustrating the insertion loss of the RF devices according to the first modification and the comparative example.

FIG. 8 illustrates the insertion loss of an RF signal input to the RF device 1A or 101 from the input/output terminal 92. In FIG. 8, the insertion loss of a transmitting filter having Band 1 as its passband is illustrated.

As illustrated in FIG. 8, the insertion loss in the passband is smaller in the first modification than in the comparative example. According to the RF device 1A of the first modification, the occurrence of the insertion loss in the passband can be reduced or prevented compared to the RF device 101 of the comparative example.

The configuration of an RF device 1B according to a second modification of an example embodiment of the present invention will be described with reference to FIG. 9. In the second modification, an example in which the first end e1 of the lead-out line 34b is connected to the signal line 34a will be described.

FIG. 9 is a diagram schematically illustrating the cross-section of the RF device 1B.

As illustrated in FIG. 9, the RF device 1B includes the substrate 30 including the first surface 31 and the second surface 32, and the chip component 10 mounted on the substrate 30. The configuration of the chip component 10 of the second modification is the same as or similar to that of the current example embodiment.

The substrate 30 includes the signal electrode 33, the first line 34 connected to the signal electrode 33, the reference potential electrode 35, the second line 36 connected to the reference potential electrode 35, and the inductor 40. The configuration of the signal electrode 33, the reference potential electrode 35, the second line 36, and the inductor 40 is the same as or similar to that of the present example embodiment.

The lead-out line 34b of the second modification is a line to electrically connect the signal electrode 33 and the inductor 40. The first end e1 of the lead-out line 34b is connected to a portion of the signal line 34a. The connection point c2 of the signal line 34a, to which the first end e1 of the lead-out line 34b is connected, corresponds to the first node n1 in the circuit configuration diagram of FIG. 2.

A first end of the first line 34 is connected to the signal electrode 33. The first line 34 includes two second ends in which the land electrode 38, which is one of the two second ends, is connected to the bump electrode 50, and the other second end is connected to the first end portion 41 of the inductor 40.

For example, the lead-out line 34b extends from an end portion of the first conductor pattern p1 that is closest to the first surface 31 among the multiple conductor patterns p, and is connected to the signal line 34a. Specifically, the first end e1 of the lead-out line 34b is connected to the signal line 34a on the second surface 32 side relative to the first end portion 41 of the inductor 40. More specifically, the first end e1 of the lead-out line 34b is connected to the connection point c2 of the signal line 34a on the second surface 32 side relative to a second conductor pattern p2 that is closest to the second surface 32 among the multiple conductor patterns p.

In the RF device 1B of the second modification, the signal electrode 33 provided on the second surface 32 of the substrate 30 is electrically connected to the functional elements 13 and 13a of the chip component 10 with the signal line 34a interposed therebetween. Additionally, the second end e2 of the lead-out line 34b is connected to the first end portion 41 of the inductor 40, and the first end e1 of the lead-out line 34b is connected to the signal line 34a on the second surface 32 side relative to the first end portion 41 of the inductor 40. According to this configuration, the distance from the point (connection point c1) where the signal line 34a is connected to the signal electrode 33 to the point (connection point c2) where the lead-out line 34b is connected to the signal line 34a can be made shorter than that in the comparative example. Therefore, the RF signal input to the signal electrode 33 is branched at the connection point c2 located near the signal electrode 33 and transmitted separately through the signal line 34a and the lead-out line 34b. This can shorten the line portion of the signal line 34a where a large current flows and reduce or prevent the occurrence of unwanted loss in the RF signal.

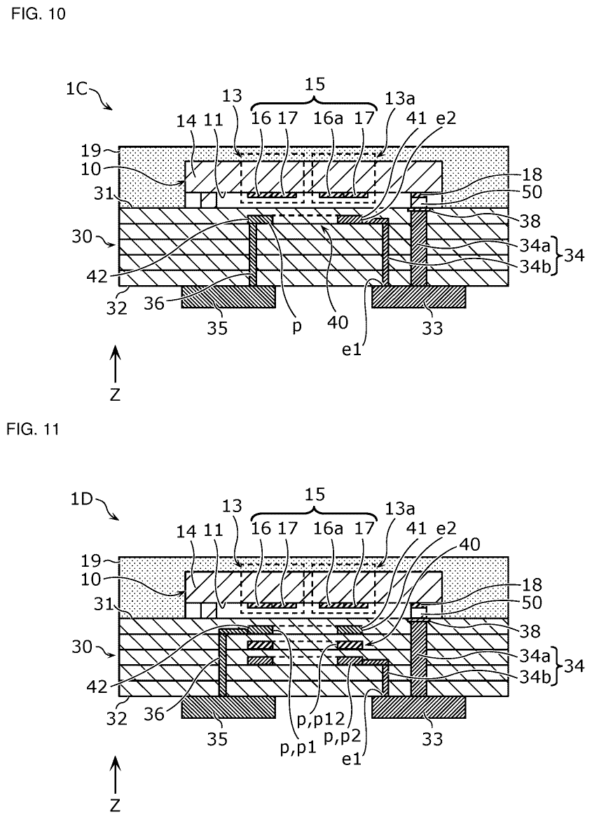

The configuration of an RF device 1C according to a third modification of an example embodiment of the present invention will be described with reference to FIG. 10. In the third modification, an example in which the inductor 40 includes a single layer of a conductor pattern p will be described.

FIG. 10 is a diagram schematically illustrating the cross-section of the RF device 1C.

As illustrated in FIG. 10, the RF device 1C includes the substrate 30 including the first surface 31 and the second surface 32, and the chip component 10 mounted on the substrate 30. The configuration of the chip component 10 of the third modification is the same as or similar to that of the current example embodiment.

The substrate 30 includes the signal electrode 33, the first line 34 connected to the signal electrode 33, the reference potential electrode 35, the second line 36 connected to the reference potential electrode 35, and the inductor 40. The configuration of the signal electrode 33, the first line 34, the reference potential electrode 35, and the second line 36 is the same as or similar to that of the present example embodiment.

The first end portion 41 of the inductor 40 is connected to the signal electrode 33 with the lead-out line 34b interposed therebetween. The second end portion 42 of the inductor 40 is electrically connected to the reference potential electrode 35.

Specifically, the inductor 40 of the third modification includes a conductor pattern p having about ¾ turns. The conductor pattern p is provided on the base material sheet and is parallel or substantially parallel to the first surface 31. A first end portion of the conductor pattern p is connected to the signal electrode 33 with the first line 34 interposed therebetween, and a second end portion of the conductor pattern p is connected to the reference potential electrode 35 with the second line 36 interposed therebetween.

In the RF device 1C of the third modification, the first end e1 of the lead-out line 34b is connected to the signal electrode 33 on the second surface 32 side relative to the first end portion 41 of the inductor 40. This, in turn, makes it possible to achieve the same or substantially the same advantageous effects as those achieved in the example embodiments described above.

The configuration of an RF device 1D according to a fourth modification of an example embodiment of the present invention will be described with reference to FIG. 11. In the fourth modification, an example in which the inductor 40 is vertically inverted will be described.

FIG. 11 is a diagram schematically illustrating the cross-section of the RF device 1D.

As illustrated in FIG. 11, the RF device 1D includes the substrate 30 including the first surface 31 and the second surface 32, and the chip component 10 mounted on the substrate 30. The configuration of the chip component 10 of the fourth modification is the same as or similar to that of the current example embodiment.

The substrate 30 includes the signal electrode 33, the first line 34 connected to the signal electrode 33, the reference potential electrode 35, the second line 36 connected to the reference potential electrode 35, and the inductor 40. The configuration of the signal electrode 33, the first line 34, the reference potential electrode 35, and the second line 36 is the same as or to that of the current example embodiment.

The inductor 40 of the fourth modification includes the first end portion 41 located closer to the second surface 32 of the substrate 30 than the second end portion 42. In other words, the inductor 40 of the fourth modification includes the second end portion 42 disposed closer to the first surface 31 of the substrate 30 than the first end portion 41. The first end portion 41 of the inductor 40 is connected to the signal electrode 33 with the lead-out line 34b interposed therebetween. The second end portion 42 of the inductor 40 is electrically connected to the reference potential electrode 35.

Specifically, the inductor 40 of the fourth modification includes three layers of conductor patterns p. The inductor 40 includes a first conductor pattern p1 that is closest to the first surface 31 among the multiple conductor patterns p, a second conductor pattern p2 that is closest to the second surface 32, and another conductor pattern p12 that is located between the first conductor pattern p1 and the second conductor pattern p2. The second conductor pattern p2 is connected to the signal electrode 33 with the lead-out line 34b interposed therebetween. The first conductor pattern p1 is connected to the reference potential electrode 35 with the second line 36 interposed therebetween.

In the RF device 1D of the fourth modification, the first end e1 of the lead-out line 34b is directly connected to the signal electrode 33 on the second surface 32 side relative to the first end portion 41 of the inductor 40. This, in turn, makes it possible to achieve the same or substantially the same advantageous effects as those of the example embodiments described above.

Additionally, in the RF device 1D, the lead-out line 34b extends from an end portion of the second conductor pattern p2 that is closest to the second surface 32 among the multiple conductor patterns p, thus shortening the length of the lead-out line 34b and reducing the resistance of the lead-out line 34b.

Furthermore, in the RF device 1D, the second conductor pattern p2 connected to the signal electrode 33 is spaced apart from the conductor portion 15 of the chip component 10, and the first conductor pattern p1 connected to the reference potential electrode 35 is located between the second conductor pattern p2 and the conductor portion 15, thus reducing or preventing deterioration of RF characteristics.

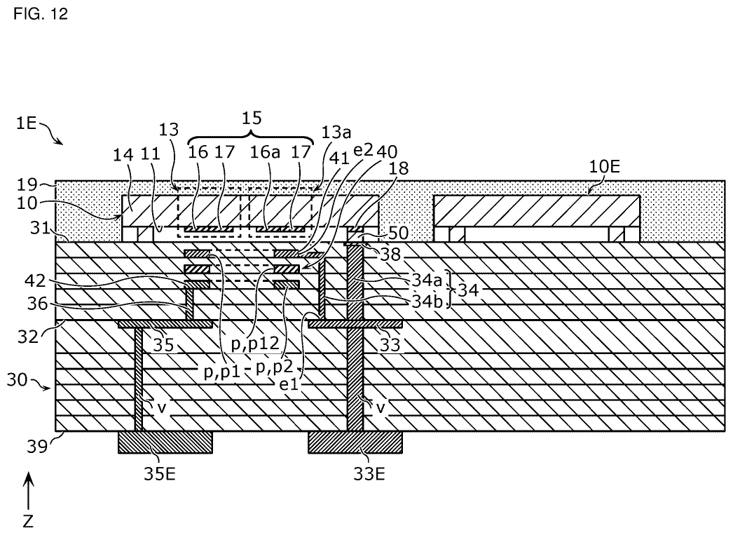

The configuration of an RF device 1E according to a fifth modification of an example embodiment of the present invention will be described with reference to FIG. 12. In the fifth modification, an example in which the configuration of the RF device 1 of the above-described example embodiment is incorporated into a module substrate will be described.

FIG. 12 is a diagram schematically illustrating the cross-section of the RF device 1E.

As illustrated in FIG. 12, the RF device 1E includes the substrate 30 including the first surface 31 and the second surface 32, and the chip component 10 mounted on the substrate 30. The configuration of the chip component 10 of the fifth modification is the same as or similar to that of the current example embodiment.

Another chip component 10E mounted on the first surface 31 of the substrate 30 is also illustrated in FIG. 12. The chip component 10E is, for example, an LNA or a power amplifier, and is connected to the second end portion of the functional element 13 of the chip component 10.

The substrate 30 is, for example, a multilayer substrate formed by laminating multiple base material sheets. The substrate 30 may be, for example, a circuit board including a ceramic material, or a flexible circuit board including a resin material.

The first surface 31 and the second surface 32, which are the two main surfaces of the substrate 30, are parallel or substantially parallel to each other. The first surface 31 is located on the front surface of the substrate 30, and the second surface 32 is located in the substrate 30. The first surface 31 is a surface on which the chip component 10 is mounted. The second surface 32 is not a back surface 39 of the substrate 30, but is the boundary surface between the base material sheet and the signal electrode 33 and the reference potential electrode 35.

The substrate 30 includes the signal electrode 33, the first line 34 connected to the signal electrode 33, the reference potential electrode 35, the second line 36 connected to the reference potential electrode 35, and the inductor 40.

The first end portion 41 of the inductor 40 is connected to the signal electrode 33 with the first line 34 interposed therebetween. The second end portion 42 of the inductor 40 is electrically connected to the reference potential electrode 35. Specifically, the second end portion 42 of the inductor 40 is connected to the reference potential electrode 35 with the second line 36 interposed therebetween.

The inductor 40 includes multiple conductor patterns p and the conductor via vi connecting the conductor patterns p to one another. Each conductor pattern p is provided on the base material sheet of the corresponding layer and is parallel or substantially parallel to the first surface 31. The inductor 40 is configured such that the coil axis of the inductor 40 is perpendicular or substantially perpendicular to the substrate 30.

The inductor 40 illustrated in FIG. 12 includes three layers of conductor patterns p. The inductor 40 includes a first conductor pattern p1 that is closest to the first surface 31 among the multiple conductor patterns p, a second conductor pattern p2 that is closest to the second surface 32, and another conductor pattern p12 that is located between the first conductor pattern p1 and the second conductor pattern p2. The first conductor pattern p1 is connected to the signal electrode 33 with the first line 34 interposed therebetween. The second conductor pattern p2 is connected to the reference potential electrode 35 with the second line 36 interposed therebetween.

The reference potential electrode 35 is provided on the second surface 32 of the substrate 30. The reference potential electrode 35 is an internal terminal for grounding, for example, and is set to a reference potential (e.g., a ground potential). The reference potential electrode 35 in the fifth modification corresponds to ground in the circuit configuration diagram of FIG. 2. The reference potential electrode 35 is connected to an external terminal 35E on the back surface 39 of the substrate 30 with a conductor via v in the substrate 30 interposed therebetween.

The second line 36 is provided inside the substrate 30. A first end of the second line 36 is connected to the second end portion 42 of the inductor 40, and a second end of the second line 36 is connected to the reference potential electrode 35.

The signal electrode 33 is provided on the second surface 32 of the substrate 30. The signal electrode 33 is an internal terminal for signal input, for example, and receives an RF signal input to the antenna element 97. The signal electrode 33 in the fifth modification corresponds to the input/output terminal 91 in the circuit configuration diagram of FIG. 2. The signal electrode 33 is electrically connected to the functional elements 13 and 13a of the chip component 10 with the signal line 34a, which is a portion of the first line 34, and the bump electrode 50 interposed therebetween. The signal electrode 33 is also connected to an external terminal 33E on the back surface 39 of the substrate 30 with a conductor via v in the substrate 30 interposed therebetween.

The first line 34 is provided inside the substrate 30 and on the first surface 31. The first line 34 includes multiple line patterns, the conductor via vs, and the conductor via vd provided in the substrate 30. On the first surface 31, the land electrode 38, which is a portion of the first line 34, is provided. The first line 34 includes the signal line 34a and the lead-out line 34b.

The signal line 34a is a line that electrically connects the signal electrode 33 and the bump electrode 50. A first end of the signal line 34a is connected to the signal electrode 33 on the second surface 32 of the substrate 30. The land electrode 38, which is a second end of the signal line 34a, is exposed to the first surface 31 of the substrate 30 and is connected to the bump electrode 50. That is, the signal line 34a extends from the second surface 32 to the first surface 31 and is electrically connected to the functional elements 13 and 13a of the chip component 10.

The lead-out line 34b is a line to electrically connect the signal electrode 33 and the inductor 40. The first end e1 of the lead-out line 34b is connected to the signal electrode 33, and the second end e2 of the lead-out line 34b is connected to the first end portion 41 of the inductor 40.

In the present modification, the first end e1 of the lead-out line 34b is directly connected to the signal electrode 33 on the second surface 32 side relative to the first end portion 41 of the inductor 40. Additionally, the first end e1 of the lead-out line 34b is connected to a region different from the signal line 34a on the signal electrode 33. The signal electrode 33, to which the first end e1 of the lead-out line 34b is connected, corresponds to the input/output terminal 91 and the first node n1 in the circuit configuration diagram of FIG. 2.

In the RF device 1E of the fifth modification, the signal electrode 33 provided on the second surface 32 of the substrate 30 is electrically connected to the functional elements 13 and 13a of the chip component 10 with the signal line 34a interposed therebetween. Additionally, the second end e2 of the lead-out line 34b is connected to the first end portion 41 of the inductor 40, and the first end e1 of the lead-out line 34b is connected to the signal electrode 33 on the second surface 32 side relative to the first end portion 41 of the inductor 40. According to this configuration, the RF signal input to the signal electrode 33 is branched at the signal electrode 33 and transmitted separately through the signal line 34a and the lead-out line 34b. Therefore, it is possible to reduce or prevent a large current from flowing through the signal line 34a. This, in turn, makes it possible to reduce or prevent the occurrence of unwanted loss in the RF signal.

In the above description, examples in which the lead-out line 34b is connected to the signal electrode 33 have been described. However, the configuration is not limited thereto. For example, the lead-out line 34b may extend from the first end portion 41 of the inductor 40 and be connected to the signal line 34a on the second surface 32 side relative to the first end portion 41.

RF device according to example embodiments of the present invention and modifications are described.

An RF device according to an example embodiment of the present invention includes the substrate 30 including the first surface 31 and the second surface 32, and the chip component 10 mounted on the first surface 31 of the substrate 30. The substrate 30 includes the signal electrode 33, the signal line 34a, the lead-out line 34b, the reference potential electrode 35, and the inductor 40. The signal electrode 33 is provided on the second surface 32 and is electrically connected to the functional element 13 of the chip component 10 with the signal line 34a interposed therebetween. The lead-out line 34b includes the first end e1 and the second end e2. The first end portion 41 of the inductor 40 is connected to the second end e2 of the lead-out line 34b, and the second end portion 42 of the inductor 40 is connected to the reference potential electrode 35. The first end e1 of the lead-out line 34b is connected to the signal electrode 33 or the signal line 34a on the second surface 32 side relative to the first end portion 41 of the inductor 40.

For example, the first end e1 of the lead-out line 34b is connected to the signal electrode 33 on the second surface 32 side relative to the first end portion 41 of the inductor 40. This causes an RF signal input to the signal electrode 33 to be branched at the signal electrode 33 and transmitted separately through the signal line 34a and the lead-out line 34b. Therefore, it is possible to reduce or prevent a large current from flowing through the signal line 34a. This, in turn, makes it possible to reduce or prevent the occurrence of unwanted loss in the RF signal.

For example, the first end e1 of the lead-out line 34b is connected to the signal line 34a on the second surface 32 side relative to the first end portion 41 of the inductor 40. This causes an RF signal input to the signal electrode 33 to be branched at the first end e1 of the lead-out line 34b and transmitted separately through the signal line 34a and the lead-out line 34b. Therefore, it is possible to shorten the line portion of the signal line 34a where a large current flows. This, in turn, makes it possible to reduce or prevent the occurrence of unwanted loss in the RF signal.

In an RF device according to an example embodiment of the present invention, the first end portion 41 of the inductor 40 may be connected to the signal electrode 33 or the signal line 34a with the lead-out line 34b interposed therebetween, and the second end portion 42 of the inductor 40 may be connected to the reference potential electrode 35 with another line (e.g., the second line 36), different from both the signal line 34a and the lead-out line 34b, interposed therebetween.

Accordingly, the RF signal input to the signal electrode 33 is transmitted separately through the signal line 34a and the lead-out line 34b. Therefore, it is possible to reduce or prevent a large current from flowing through the signal line 34a. This, in turn, makes it possible to reduce or prevent the occurrence of unwanted loss in the RF signal.

In an RF device according to an example embodiment of the present invention, the inductor 40 may include multiple conductor patterns p and the conductor via vi provided in the substrate 30, and the lead-out line 34b may extend from an end portion of a conductor pattern that is closest to the first surface 31 among the multiple conductor patterns p, and may be connected to the signal electrode 33 or the signal line 34a.

Accordingly, even if the lead-out line 34b extends from an end portion of a conductor pattern that is close to the first surface 31, the RF signal input to the signal electrode 33 is branched at the signal electrode 33 or the connection point c2 and transmitted separately through the signal line 34a and the lead-out line 34b. Therefore, it is possible to reduce or prevent a large current from flowing through the signal line 34a. This, in turn, makes it possible to reduce or prevent the occurrence of unwanted loss in the RF signal.

In an RF device according to an example embodiment of the present invention, the inductor 40 may include multiple conductor patterns p and the conductor via vi provided in the substrate 30, and the first end e1 of the lead-out line 34b may be connected to the signal line 34a on the second surface 32 side relative to a conductor pattern that is closest to the second surface 32 among the multiple conductor patterns p.

Accordingly, it is possible to shorten the distance from the point (connection point c1) where the signal line 34a is connected to the signal electrode 33 to the point (connection point c2) where the first end e1 of the lead-out line 34b is connected to the signal line 34a. Therefore, the RF signal input to the signal electrode 33 is branched at the connection point c2 (or the first end e1) and transmitted separately through the signal line 34a and the lead-out line 34b. This can shorten the line portion of the signal line 34a where a large current flows and reduce or prevent the occurrence of unwanted loss in the RF signal.

In an RF device according to an example embodiment of the present invention, the inductor 40 may include multiple conductor patterns p and the conductor via vi provided in the substrate 30, and the lead-out line 34b may extend from an end portion of a conductor pattern that is closest to the second surface 32 among the multiple conductor patterns p, and may be connected to the signal electrode 33 or the signal line 34a.

According to this configuration, it is possible to shorten the length of the lead-out line 34b and reduce the resistance of the lead-out line 34b. This, in turn, makes it possible to reduce or prevent the occurrence of unwanted loss in the RF signal.

In an RF device according to an example embodiment of the present invention, the chip component 10 may include the functional element 13 including the base material 14 and the functional electrode 16, the functional element 13 may include one or more acoustic wave resonators, and the one or more acoustic wave resonators may include at least one of a SAW resonator, a BAW resonator, and an XBAR.

Accordingly, it is possible to reduce or prevent the occurrence of the insertion loss in the passband of the RF device.

In an RF device according to an example embodiment of the present invention, an RF signal may be input to the signal electrode 33, and the reference potential electrode 35 may be set to a ground potential.

Accordingly, it is possible to reduce or prevent a large current from flowing through the signal line 34a when an RF signal is input to the signal electrode 33. This, in turn, makes it possible to reduce or prevent the occurrence of unwanted loss in the RF signal.

In an RF device according to an example embodiment of the present invention, the first surface 31 may be located on the front surface of the substrate 30, the second surface 32 may be located on the back surface of the substrate 30, and each of the signal electrode 33 and the reference potential electrode 35 may be provided on the second surface 32.

Accordingly, it is possible to provide a surface-mounted RF device including the substrate 30 and the chip component 10.

In an RF device according to an example embodiment of the present invention, the first surface 31 may be located on the front surface of the substrate 30, and the second surface 32 may be parallel or substantially parallel to the first surface 31 and located inside the substrate 30.

Accordingly, it is possible to provide a module RF device including the substrate 30 and the chip component 10.

A multiplexer 90 according to an example embodiment of the present invention, includes an RF device according to an example embodiment of the present invention,.

Accordingly, it is possible to provide the multiplexer 90 capable of reducing or preventing the occurrence of unwanted loss in the RF signal.

Although the RF devices and multiplexers according to example embodiments of the present invention and modifications thereof have been described above, the present invention is not limited to the individual example embodiments. Any modifications conceived by those skilled in the art and applied to the example embodiments, as well as example embodiments constructed by combining elements of different example embodiments, also fall within the scope of the present invention, provided they do not depart from the spirit of the present invention.

Example embodiments of the present invention can be widely used in communication equipment such as, for example, mobile phones as an RF device or a multiplexer that can reduce or prevent the occurrence of unwanted loss in an RF signal.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A radio-frequency device comprising:
a substrate including a first surface and a second surface; and
a chip component mounted on the first surface of the substrate; wherein
the substrate includes a signal electrode, a signal line, a lead-out line, a reference potential electrode, and an inductor;
the signal electrode is located on the second surface and electrically connected to a functional element of the chip component with the signal line interposed therebetween;
the lead-out line includes a first end and a second end;
a first end portion of the inductor is connected to the second end of the lead-out line, and a second end portion of the inductor is connected to the reference potential electrode; and
the first end of the lead-out line is connected to the signal electrode or the signal line on the second surface side relative to the first end portion of the inductor.

2. The radio-frequency device according to claim 1, wherein
the first end portion of the inductor is connected to the signal electrode or the signal line with the lead-out line interposed therebetween; and
the second end portion of the inductor is connected to the reference potential electrode with another line, different from both of the signal line and the lead-out line, interposed therebetween.

3. The radio-frequency device according to claim 1, wherein
the inductor includes a plurality of conductor patterns and a conductor via in the substrate; and
the lead-out line extends from an end portion of a conductor pattern that is closest to the first surface among the plurality of conductor patterns and is connected to the signal electrode or the signal line.

4. The radio-frequency device according to claim 1, wherein
the inductor includes a plurality of conductor patterns and a conductor via in the substrate; and
the first end of the lead-out line is connected to the signal line on the second surface side relative to a conductor pattern that is closest to the second surface among the plurality of conductor patterns.

5. The radio-frequency device according to claim 1, wherein
the inductor includes a plurality of conductor patterns and a conductor via in the substrate; and
the lead-out line extends from an end portion of a conductor pattern that is closest to the second surface among the plurality of conductor patterns and is connected to the signal electrode or the signal line.

6. The radio-frequency device according to claim 1, wherein
the chip component includes the functional element including a base material and a functional electrode;
the functional element includes one or more acoustic wave resonators; and
the one or more acoustic wave resonators include at least one of a surface acoustic wave resonator, a bulk acoustic wave resonator, or a laterally excited film bulk acoustic wave resonator.

7. The radio-frequency device according to claim 1, wherein
a radio-frequency signal is input to the signal electrode; and
the reference potential electrode is set to a ground potential.

8. The radio-frequency device according to claim 1, wherein
the first surface is located on a front surface of the substrate;
the second surface is located on a back surface of the substrate; and
each of the signal electrode and the reference potential electrode is located on the second surface.

9. The radio-frequency device according to claim 1, wherein
the first surface is located on a front surface of the substrate; and
the second surface is parallel or substantially parallel to the first surface and is located inside the substrate.

10. A multiplexer comprising the radio-frequency device according to claim 1.

11. The multiplexer according to claim 10, wherein
the first end portion of the inductor is connected to the signal electrode or the signal line with the lead-out line interposed therebetween; and
the second end portion of the inductor is connected to the reference potential electrode with another line, different from both of the signal line and the lead-out line, interposed therebetween.

12. The multiplexer according to claim 10, wherein
the inductor includes a plurality of conductor patterns and a conductor via in the substrate; and
the lead-out line extends from an end portion of a conductor pattern that is closest to the first surface among the plurality of conductor patterns and is connected to the signal electrode or the signal line.

13. The multiplexer according to claim 10, wherein
the inductor includes a plurality of conductor patterns and a conductor via in the substrate; and
the first end of the lead-out line is connected to the signal line on the second surface side relative to a conductor pattern that is closest to the second surface among the plurality of conductor patterns.

14. The multiplexer according to claim 10, wherein
the inductor includes a plurality of conductor patterns and a conductor via in the substrate; and
the lead-out line extends from an end portion of a conductor pattern that is closest to the second surface among the plurality of conductor patterns and is connected to the signal electrode or the signal line.

15. The multiplexer according to claim 10, wherein
the chip component includes the functional element including a base material and a functional electrode;
the functional element includes one or more acoustic wave resonators; and
the one or more acoustic wave resonators include at least one of a surface acoustic wave resonator, a bulk acoustic wave resonator, or a laterally excited film bulk acoustic wave resonator.

16. The multiplexer according to claim 10, wherein
a radio-frequency signal is input to the signal electrode; and
the reference potential electrode is set to a ground potential.

17. The multiplexer according to claim 10, wherein
the first surface is located on a front surface of the substrate;
the second surface is located on a back surface of the substrate; and
each of the signal electrode and the reference potential electrode is located on the second surface.

18. The multiplexer according to claim 10, wherein
the first surface is located on a front surface of the substrate; and
the second surface is parallel or substantially parallel to the first surface and is located inside the substrate.
